(19) United States
(12) Patent Application Publication
(10) Pub. No.: US 2025/0347384 A1
(43) Pub. Date: Nov. 13, 2025

(54) WALL MOUNTED HITCH

(71) Applicant: Kindred Products LLC, Benton Harbor, MI (US)

(72) Inventors: Gregg Schweir, Benton Harbor, MI (US); Mark Celmer, St. Joseph, MI (US)

(21) Appl. No.: 18/662,426

(22) Filed: May 13, 2024

Related U.S. Application Data
(60) Provisional application No. 63/461,679, filed on Apr. 25, 2023.

(51) Int. Cl. F16M 13/02; B62H 3/00

(52) U.S. Cl. CPC F16M 13/022; B62H 3/00

(57) ABSTRACT

A wall mounted hitch for storage of a variety of hitch accessories designed to cooperate with known automobile trailer hitch connections includes a wall mounted support bracket, a hitch receiver, and a hinge pin oriented to allow the hitch receiver to rotate and be stored within the confines of the support bracket without the need to remove the support bracket from the wall.

### CROSS-REFERENCE TO RELATED APPLICATION

The present application claims to benefit of U.S. Provisional Application No. 63/461,679, filed Apr. 25, 2023, which is incorporated herein by reference in its entirety.

### BACKGROUND

Vehicle trailer hitches for attaching various hitch accessories such as bike racks, ski racks, tables, work surfaces, cargo carriers, and the like are known. Trailer hitches are permanently mounted to the vehicle structure to carry the loads induced by the individual hitch devices and load. More recently hitch receivers have been marketed for mounting in indoor settings like garages, basements, or other facility storage areas to improve the storage and organization of the devices when not mounted to the vehicle.

The various hitch accessories are typically designed with square tubular structures that engage with the hitch receiver. The square tubular design and the awkward size, weight, and shape of these devices does not easily allow for indoor storage because these devices are unbalanced while resting on the ground and not conducive to leaning against the wall of a garage or storage room.

Wall mounted hitches are known. One commercially available example is disclosed in the Swagman X Mount Bike Rack Storage device (Part Number 80940) that comprises a T-shaped wall mount and a hitch receiver that can pivot from side to side. Despite their advantages, known wall mounted hitches can be difficult to install and have weight-limit restrictions. Additionally, once mounted to a wall, known wall mounted hitches encroach on the indoor space when a hitch accessory mounted devices is not mounted to the hitch.

### BRIEF SUMMARY

A wall mounted hitch is provided with improved storage features for placing the hitch in a compact orientation when no hitch accessory is mounted to the wall mounted hitch.

In one aspect of the disclosure, a wall mounted hitch includes a support bracket, a hitch receiver, and a hinge pin coupling the hitch receiver to the support bracket for rotation of the hitch receiver between a use position and a storage position.

In one embodiment, the hinge pin is disposed between the proximal end and the distal end of the hitch receiver, and the hitch receiver comprises an offset at a proximal end thereof such that the hitch receiver can be rotated about the hinge pin and stored within the support bracket.

These and other features and advantages of the present disclosure will become apparent from the following description of particular embodiments, when viewed in accordance with the accompanying drawings and appended claims.

### DESCRIPTION OF THE DRAWINGS

In the drawings:

FIG. 1 is a perspective view of a wall mounted hitch according to one aspect of the disclosure, the hitch including at least a hitch receiver and a support bracket, with the hitch receiver in a use position;

FIG. 2 is an exploded view of the wall mounted hitch of FIG. 1;

FIG. 3A is a top view of the hitch receiver of FIG. 1;

FIG. 3B is a side view of the hitch receiver of FIG. 1;

FIG. 3C is a cross-sectional view of the hitch receiver taken through line III-III of FIG. 3B;

FIG. 4A is a side view of the support bracket of FIG. 1;

FIG. 4B is a front view of the support bracket of FIG. 1;

FIG. 4C is a cross-sectional view of the support bracket taken through line IVC-IVC of FIG. 4B;

FIG. 4D is a cross-sectional view of the support bracket taken through line IVD-IVD of FIG. 4B;

FIG. 5 is a rear perspective view of the wall mounted hitch showing an interface between the hitch receiver and a stiffening rib on the support bracket of FIG. 1, where the support bracket is shown in phantom line for clarity;

FIG. 6 is a perspective view of the wall mounted hitch of FIG. 1, with the hitch receiver in a storage position; and

FIG. 7 is a is a perspective view of the wall mounted hitch of FIG. 1 supporting a hitch accessory in the form of a bike rack and a bike supported on the bike rack.

### DETAILED DESCRIPTION

A wall mounted hitch having improved storage features is described herein. The present invention provides a wall mounted hitch that allows users to not only store various hitch accessories but to also utilize the intended purpose of the hitch accessory while mounted on a wall, such as a wall of a home, a garage, basement, or other building structure. The wall mounted hitch according to at least some of the aspects disclosed herein has a weight-limit exceeding that of typical hitch accessories, such that the wall mounted hitch can support items in addition to a hitch accessory. An example of this is that bicycle enthusiasts can mount their bike on a bike rack mounted to the wall mounted hitch to easily perform maintenance on the bike. Yet another example of this is that a cargo carrier mounted to the wall mounted hitch can support additional items for storage. An additional benefit of the wall mounted hitch is that the wall mounted hitch can conveniently be placed in a compact storage position when not being used to store a hitch accessory.

Referring generally to the figures, wherein like numerals indicate corresponding parts throughout the several views, a wall mounted hitch 10 according to one aspect of the disclosure is illustrated and is generally designated as 10. Certain features of the hitch 10 are functional but can be implemented in different aesthetic configurations.

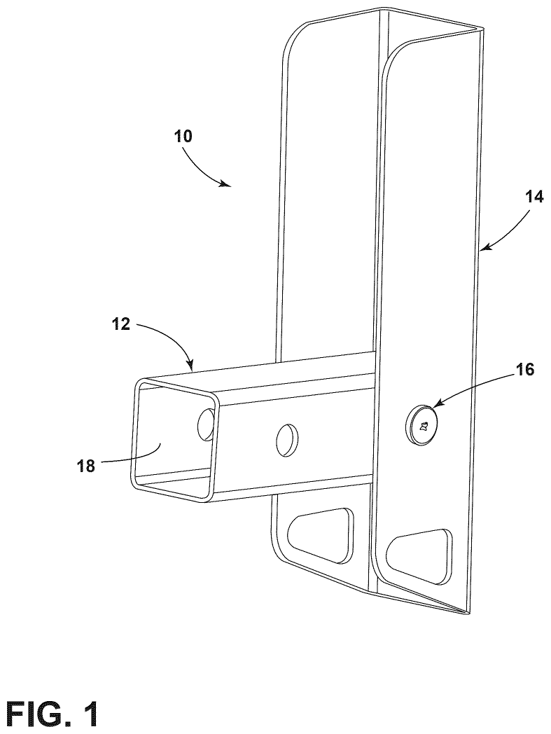

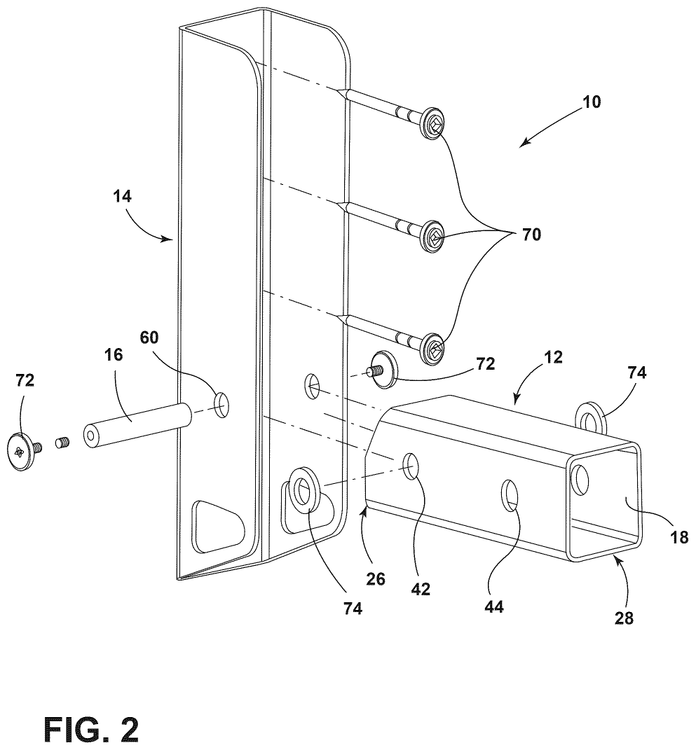

Referring to FIGS. 1 and 2, the wall mounted hitch 10 includes hitch receiver 12, a support bracket 14, and a hinge pin 16 pivotally coupling the hitch receiver 12 to the support bracket 14. The wall mounted hitch 10 functions to mount a hitch accessory (not shown) to a wall of a building structure or other substantially vertical supporting surface.

The hitch receiver 12 can replicate a standard-size hitch receiver found in vehicle applications and can receive a shank of a hitch accessory to mount the hitch accessory, via the support bracket 14, to a wall of a building structure or other substantially vertical supporting surface. The support bracket 14 is mountable to a wall of a building structure or other substantially vertical supporting surface.

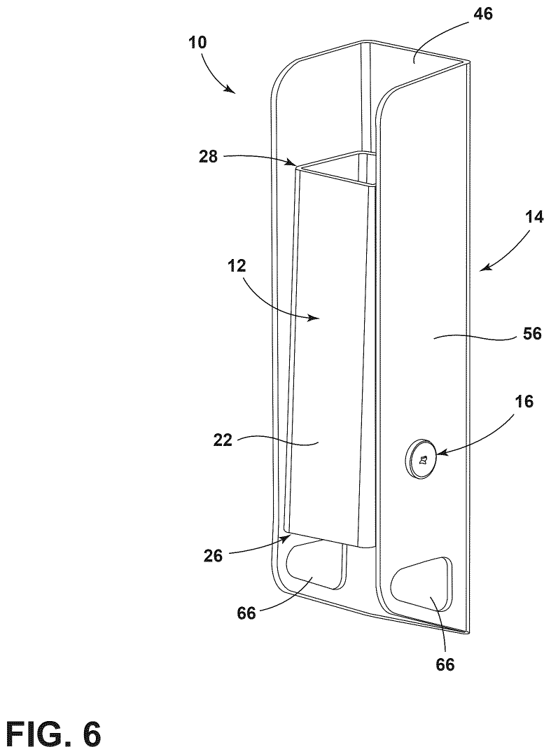

The hitch receiver 12 is moveable between an operational or use position, an example of which is shown in FIG. 1, and a storage position, an example of which is shown in FIG. 6. In the use position, the hitch receiver 12 is extended from the support bracket 14 to an orientation in which a hitch accessory can be coupled to the hitch receiver 12. In the illustrations shown, the hitch receiver 12 substantially perpendicular to the support bracket 14 in the use position. In the storage position, the hitch receiver 12 is retracted into the support bracket 14 to a compact orientation, such as substantially parallel to the support bracket 14. The support bracket 14 can remain mounted on a wall while the hitch receiver 12 moves easily between the use and storage positions. By “substantially perpendicular” the hitch receiver 12 extends generally orthogonal to or horizontally relative to the support bracket 14 in the use position, and may deviate up to 5 degrees from horizontal, or up to 10 degrees from horizontal. Accordingly, the included angle between the hitch receiver 12 and the support bracket 14 in the use position may be 90 degrees, alternatively 90 degrees±5 degrees, alternatively 90 degrees±10 degrees. By “substantially parallel” the hitch receiver 12 extends generally vertically relative to the support bracket 14 in the storage position, and may deviate up to 5 degrees from vertical, or up to 10 degrees from vertical. Accordingly, the included angle between the hitch receiver 12 and the support bracket 14 in the storage position may be 0 degrees, alternatively 0 degrees±5 degrees, alternatively 0 degrees±10 degrees.

In aspect of the disclosure, to move the wall mounted hitch from the use position to the storage position, the hitch receiver 12 is rotated in an upward direction about an axis defined by the hinge pin 16 until the hitch receiver 12 is stored at least partially, alternatively fully, inside the support bracket 14.

The hitch receiver 12 may be formed from thick-walled extruded steel dimensioned to receive a standard shank of a hitch accessory and/or a standard hitch adapter (not shown) to allow the receiver 12 to receive a smaller standard shank. In one embodiment, the nominal outside dimensions of a standard shank commonly used in vehicle application is 2 inches by 2 inches, such that the normal inside dimensions the hitch receiver 12 is 2 inches by 2 inches. In another embodiment, the nominal outside dimensions of another standard shank also commonly used in vehicle applications is 1.25 inches by 1.25 inches, such that the normal inside dimensions of the hitch receiver 12 is 1.25 inches by 1.25 inches. It is also noted that a 2-inch hitch receiver 12 can receive a 1.25-inch shank by using a standard hitch adapter (not shown). In one embodiment, the hitch receiver 12 is formed from Q345 carbon steel with a 345 Mpa yield strength.

In the illustrations shown, the hitch receiver 12 has a generally square cross section. However, other configurations are possible within the spirit and scope of embodiments of the invention. Other cross-sectional shapes that may be applied to the hitch receiver 12 and/or the hitch accessory that can be mounted to the hitch 10 include, but are not limited to, oval, diamond, horizontally elongated rectangle, vertically elongated rectangle, circular, triangular, and cross-shaped.

Referring to FIG. 2, the hitch receiver 12 can be a hollow tubular member defining a receiving volume and receiving opening 18 into which a shank of a hitch accessory may be slidably received. The hitch receiver 12 has one or more side walls and further has a first end 26 and a second end 28. The first end 26 is also referred to herein as the proximal end and the second end 28 is also referred to herein as the distal end and includes the receiving opening 18. The term “proximal” as used herein refers to that end or portion of the hitch receiver 12 that is situated toward the support bracket 14, i.c., toward a wall of a building structure or other substantially vertical supporting surface. The term “distal” as used herein refers to that end or portion of the hitch receiver 12 that is situated away from the support bracket 14, i.e., outward from a wall of a building structure or other substantially vertical supporting surface.

The support bracket 14 is a separate part from the hitch receiver 12, i.e., is separately formed from the hitch receiver 12, and is coupled with the hitch receiver by the hinge pin 16 such that the hitch receiver 12 can move or pivot relative to the support bracket 14 and while the support bracket is fixedly mounted to a wall or other supporting surface.

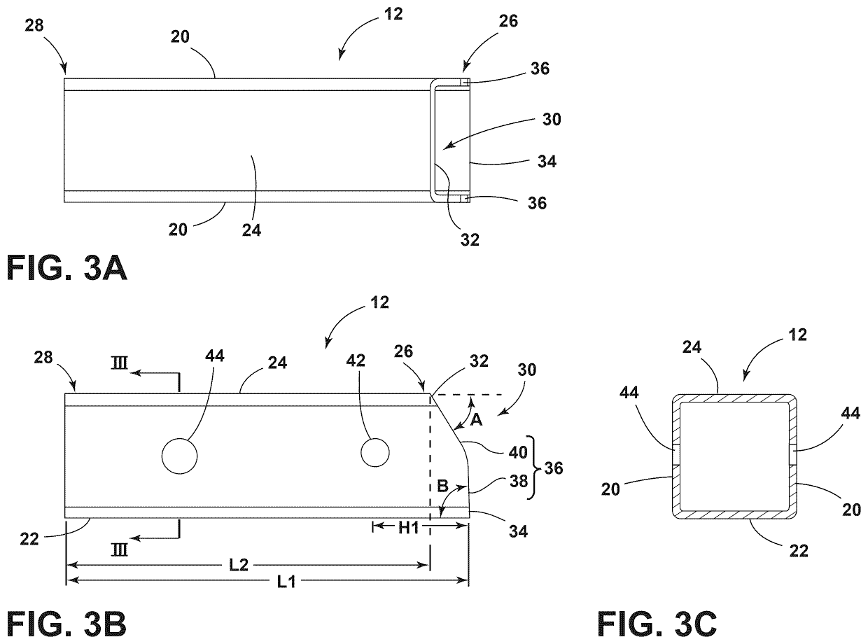

Referring to FIGS. 3A-3C, the hitch receiver 12 has one or more side walls forming a hollow tubular member. For a generally square hitch receiver 12 as shown, the hitch receiver 12 has two side walls 20, a bottom wall 22, and a top wall 24, and the walls are generally the same width and create approximately 90-degree angles where the walls meet.

In one aspect of the disclosure, the hitch receiver 12 includes an offset 30 between the top wall 24 and the bottom wall 22 at the proximal end 26 that provides sufficient clearance between the hitch receiver 12 and the support bracket 14 to allow the hitch receiver 12 to be pivoted and stored substantially within the support bracket 14. In embodiments where the hinge pin 16 is disposed between the proximal and distal ends 26, 28 of the hitch receiver 12, the offset 30 allows the hitch receiver 12 be rotated upwardly to a substantially vertical position.

In one embodiment, a proximal edge 32 of the top wall 24, also referred to herein as top proximal edge 32, may be offset from a proximal edge 34 of the bottom wall 22, also referred to herein as bottom proximal edge 34, e.g., the top proximal edge 32 may be disposed distally of the bottom proximal edge 34 to form the offset 30. Proximal edges 36 of the side walls 20, also referred to herein as side proximal edges 36, are shaped to join the bottom and top proximal edges 32, 34. Various shapes for the side proximal edges 36 are possible, including the side proximal edges 36 being angled and/or curved to join the offset top and bottom edges proximal edges 32, 34.

The side proximal edges 36 can, in one embodiment, include a lower edge portion 38 that meets the bottom wall 22 and an upper edge portion 40 that meets the top wall 24. The lower edge portion may abut the support bracket 14 in the use position, whereas the upper edge portion 40 angles away from the support bracket 14 toward the top wall 24. In an example embodiment, the upper edge portion 40 extends at an angle A of approximately 50 to 70 degrees to the top wall 24, alternatively approximately 58 degrees. The lower edge portion 38 extends at an angle B of approximately 85 to 90 degrees to the bottom wall 22, alternatively approximately 86 to 88 degrees.

The hitch receiver 12 includes a pair of aligned hinge pin apertures 42 that cooperate with both the support bracket 14 and the hinge pin 16. The hinge pin apertures 42 are located such that at least a portion of the proximal end 26 is in direct contact with the support bracket 14 when the hitch receiver 12 is in the use position.

In one non-limiting example, a length L1 of the bottom wall 22 is about 193.5 mm and a length L2 of the top wall 24 is about 174 mm, the angle A at the offset 30 is approximately 58 degrees, and the hinge pin apertures 42 are disposed at a distance H1 of about 43 to 44 mm from the proximal end 26.

The hitch receiver 12 can include hitch pin holes 44, or through-holes, formed in each of the side walls 20. The hitch pin holes 44 may be located closer to the distal end 28 of the hitch receiver 12 than the proximal end 26 and can receive a standard hitch pin (not shown) to lock to a hitch accessory to the hitch receiver 12. For example, with the shank of the hitch accessory inserted into the receiver 12, corresponding holes in the shank are aligned with hitch pin holes 44, and the hitch pin passes through the aligned holes. A threaded nut and/or cotter pin (not shown) may be provided to secure the hitch pin.

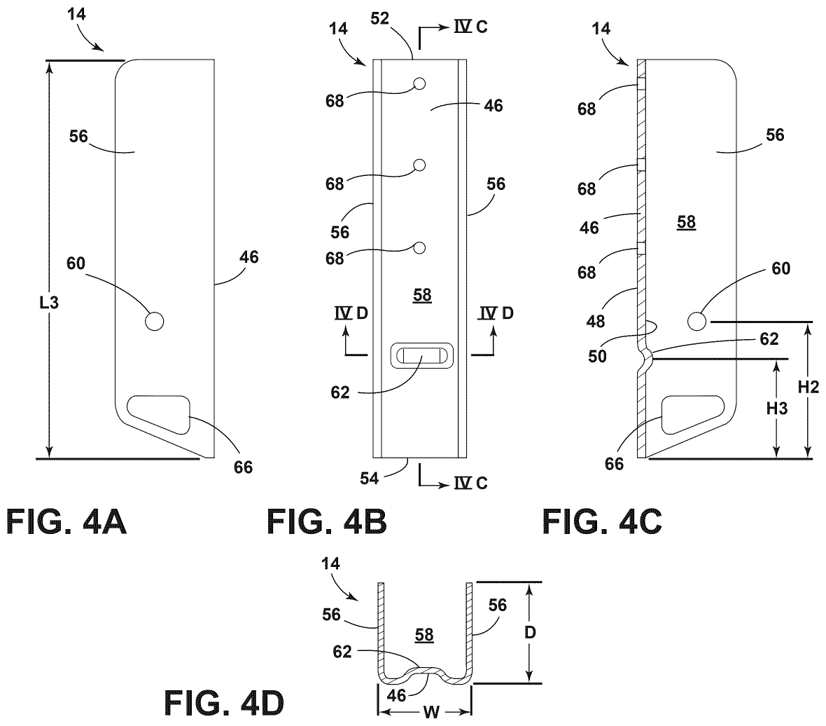

Referring to FIGS. 4A-4D, the support bracket 14 can be sized to span the width of the hitch receiver 12 and can be manufactured from steel or aluminum U-channel. Alternatively, the support bracket 14 can be made of three individual pieces welded together to form a U-shaped channel. In one embodiment, the support bracket 14 is formed from Q345 carbon steel with a 345 Mpa yield strength.

The support bracket 14 comprises a base plate 46 having a rear surface 48, a front surface 50, a top edge 52, and a bottom edge 54. The base plate 46 can be rectangular, although other shapes are possible. In one embodiment, a length L3 of the support bracket 14, which can be defined as a distance between the top edge 52 and the bottom edge 54 of the base plate 46, is greater than a length of the hitch receiver 12, e.g., the maximum length L2, in the storage position. In other embodiments, the length L3 of the support bracket 14 may be equal to or less than the length L2 of the hitch receiver 12.

The support bracket 14 comprises spaced side plates 56 extending orthogonally relative to the front surface 50 to define a receiving space 58 therebetween. The side plates 56 may be formed integrally with the base plate 46, for example where the support bracket 14 is manufactured from steel or aluminum U-channel. In other embodiments, the side plates 56 can be welded to the base plate 46.

The receiving space 58 is sized to accommodate at least the proximal end of the hitch receiver 12 in the use position and to accommodate the entire, or substantially the entire, hitch receiver 12 in the storage position. In one embodiment, the receiving space 58 accommodates the hitch receiver 12 in vertical, or substantially vertical, orientation in the storage position.

The hitch receiver 12 may rest at least partially against the front surface 50 of the base plate 46 in the stored position. As shown in FIG. 6, the distal end 28 of the hitch receiver 12, now oriented to define an upper end of the hitch receiver 12, rests against the base plate 46. In other embodiments, the hitch receiver 12 may be stored vertically without touching the base plate 46.

The support bracket 14 includes a pair of aligned hinge pin apertures 60 that accommodate the hinge pin 16 and are aligned with the hinge pin apertures 42 of the hitch receiver 12. The hinge pin apertures 60 can be located on the side plates 56 at a location that will accommodate the full length of the hitch receiver 12 when the hitch receiver 12 is pivoted to the storage position. In one embodiment, the hinge pin aperture 60 is located nearer to a lower end of the support bracket 14 than an upper end, e.g., closer to the bottom edge 54 than the top edge 52.

In one non-limiting example, the support bracket 14 is about 310 mm in length L3, about 74 mm in width W, and about 75 mm in depth D, and the hinge pin apertures 60 are disposed at a distance H2 of about 107 mm from the bottom edge 54.

A stiffening rib 62 is disposed on the front surface 50 of the base plate 46 of the support bracket 14 at a location coincident with the proximal end 26 of the hitch receiver 12 in the use position. The stiffening rib 62 provides additional structural support to the support bracket 14 and creates a defined interference between the hitch receiver 12 and the support bracket 14 when the hitch receiver 12 is in the use position, e.g., positioned perpendicular to the support bracket 14. In one non-limiting example, the stiffening rib 62 is disposed at a distance H3 of about 81 mm from the bottom edge 54.

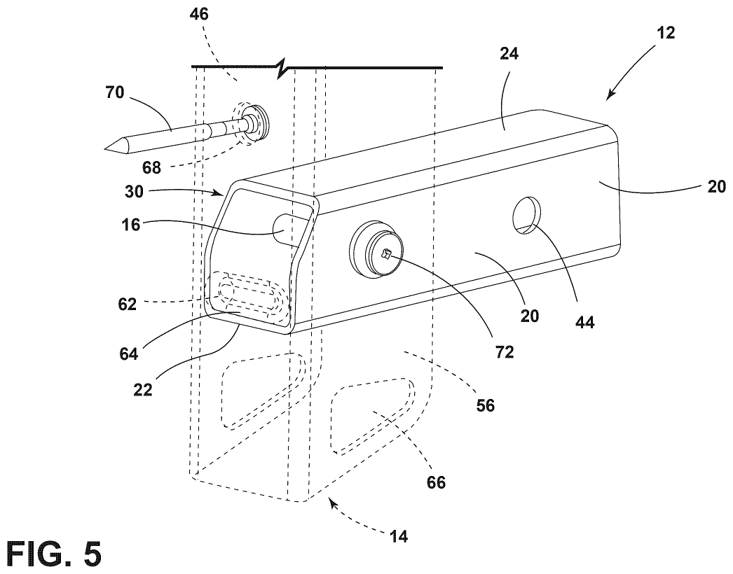

Referring to FIG. 5, the stiffening rib 62 can extend generally horizontally across the base plate 46 and can fit between the side walls 20 of the hitch receiver 12. The stiffening rib 62 is typically formed by stamping the feature into the base plate 46, however other interference features such as a weld bead or rivet heads are also contemplated.

In one embodiment, the stiffening rib 62 is at a location coincident with an upper surface 64 of the bottom wall 22 of the hitch receiver 12 in the use position. The upper surface 64 of the bottom wall 22 also defines an interior surface of the hitch receiver 12. Upper surface 64 rotates into engagement with the stiffening rib 62 when moving from the storage position to the use position and remains in engagement with the stiffening rib 62 in the use position.

Optionally, the support bracket 14 further comprises at least one lock securing aperture 66 in at least one of the side plates 56. The lock securing aperture 66 provides a way to securely lock hitch accessories mounted to the hitch 10 using a separate commonly known locking device such as a cable and key lock assembly to physically secure the auxiliary device and the product on the device to the facility structure. Preferably, the lock securing aperture is below the hinge pin 16 but may be provided elsewhere on the support bracket 14.

A plurality of mounting holes 68 are centrally located along the base plate 46 and receive mounting fasteners 70, a non-limiting example of which are structural screws, to secure the support bracket 14 to a wall of a building structure or other substantially vertical supporting surface. In one example, the support bracket 14 is mounted by screwing fasteners 70 directly into a wall stud. The mounting holes 68 may be disposed above the hinge pin apertures 60 and/or above the stiffening rib 62 and are spaced apart to distribute the weight of mounted hitch accessories across a larger arca.

In one example, the fasteners 70 can be screws configured for 1,000 lbs. or greater pull-out force. Various dimensions are possible, and in one embodiment are 90 mm in length and/or have a major diameter of 7 mm.

The hinge pin 16 can include a pair of end cap screws 72 and can be constructed of high strength steel. In one embodiment, the steel is a Y45Mn carbon steel with a 347 Mpa yield strength. The end cap screws 72 are secured to both ends of the hinge pin 16 to secure the hitch receiver 12 and support bracket 14 as an assembly, e.g., as hitch 10.

Optionally, washers 74 are positioned on the hinge pin 16 between each side wall 20 of the hitch receiver and each side plate 56 of the support bracket 14 to prevent binding between the two when the hitch receiver 12 is rotated.

Referring to FIG. 6, to place the wall mounted hitch 10 in the storage position, the hitch receiver 12 can be rotated in an upward direction about an axis defined by the hinge pin 16 until the hitch receiver 12 is stored at least partially, alternatively fully, inside the support bracket 14. For example, the hitch receiver 12 can be rotated from a substantially horizontal position in which the hitch receiver 12 is substantially perpendicular to the base plate 46 of the support bracket 14 to a substantially vertical position in which the hitch receiver 12 is substantially parallel to the base plate 46.

In the storage position, the top wall 24 of the hitch receiver 12 is generally flush with the base plate 46 of the support bracket 14 and the side walls 20 of the hitch receiver 12 are generally flush with the corresponding side plates 56 of the support bracket 14. The bottom wall 22 of the hitch receiver 12 faces outwardly and may be fully inside of the corresponding support bracket side plate 56 or may extend partially beyond the side plates 56.

In one embodiment, the hitch receiver 12 may be held in the storage position by a friction fit at the hinge pin 16 between the side walls 20 of the receiver 12 and the side plates 56 of the support bracket 14. In one example, the interference fit can require the application of a pull-out force of approximately 5-8 lbs. to deploy the hitch receiver 12, e.g., to move the hitch receiver 12 from the storage position to the use position. Other means for maintain the hitch receiver 12 in the storage position are possible.

In one embodiment, and in addition to or as an alternative to a friction fit at the hinge pin 16 described above, the distal end 28 of the hitch receiver 12 may be angled back toward the base plate 46 in the storage position, which can help maintain the hitch receiver 12 in the storage position. The over-center position of the hitch receiver 12 may include the distal end 28 resting against the base plate 46 or being tilted toward but not touching the base plate 46.

Referring to FIGS. 1, 5, and 6, the offset 30 at the proximal end 26 of the hitch receiver 12 allows for the hitch receiver 12 to pivot vertically. The longer dimension of the bottom wall 22 creates an interference fit with the support bracket 14 and stiffening rib 62 when the hitch receiver 12 is positioned perpendicular to the support bracket 14. The bottom wall 22 engages the stiffening rib 62 on the support bracket 14 to prevent any further movement of the hitch receiver 12 relative to the support bracket 14. This interference provides enhanced structural integrity when the hitch receiver 12 is positioned perpendicular to the support bracket 14 because vertical loads applied to the hitch receiver are transferred through the hitch receiver 12, to the support bracket 14 and ultimately into the facility structure.

When the support bracket 14 and hitch receiver 12 are constructed of the materials described herein and installed in accordance with the mounting instructions herein, the wall mounted hitch receiver can carry an operating load of at least 300 lbs., alternatively up to 310 lbs.

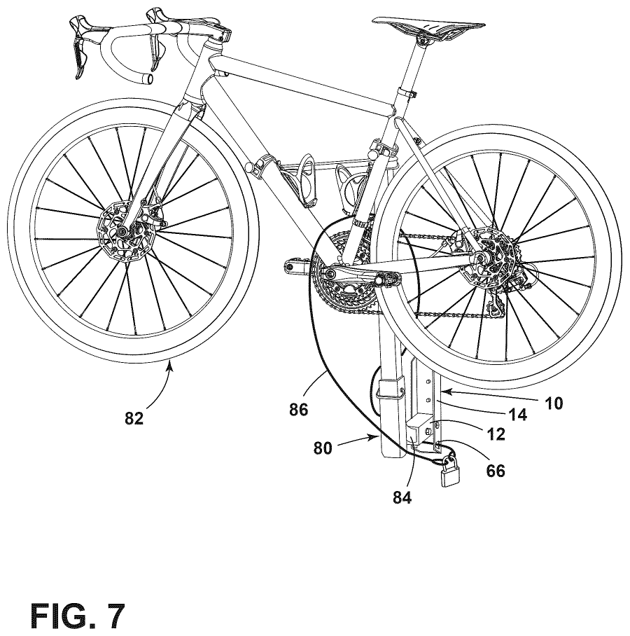

One non-limiting example of a hitch accessory 80 mounted to the wall mounted hitch 10 is shown in FIG. 7, where the hitch accessory 80 comprises a bike rack. The wall mounted hitch 10 according to at least some of the aspects disclosed herein has a weight-limit exceeding that of typical hitch accessories, such that the wall mounted hitch 10 can support items in addition to the hitch accessory 80. In FIG. 7, the wall mounted hitch 10 supports a bike 82 mounted on the bike rack 80. The hitch receiver 12 receives a shank 84 of the hitch accessory 80 to mount the hitch accessory 80, via the support bracket 14, to a wall of a building structure or other substantially vertical supporting surface. A locking device 86, such as a cable and key lock assembly, physically secures the hitch accessory 80 and bike 82 on the wall mounted hitch 10 to the building structure.

In one aspect of the disclosure, the wall mounted hitch 10 may be mounted to a wall of a building structure or other substantially vertical supporting surface and used in the following manner:
1. Locate a wall stud and mark accordingly.
2. Center the support bracket 14 on the stud.
3. Pre-drill pilot holes into the studs at the locations of the mounting holes 68.
4. Drive fasteners 70 through each mounting hole 68 and into the stud.
5. Rotate the hitch receiver 12 down into the use position so that the hitch receiver 12 is perpendicular to the support bracket 14.
6. Mount the hitch accessory 80 on the hitch receiver 12.
7. Optionally, mount an item, e.g., bike 82, on the hitch accessory 80.

When no hitch accessory 80 is mounted to the hitch receiver 12, the hitch receiver 12 can be rotated up to the vertical position for storage.

Directional terms, such as “vertical,” “horizontal,” “top,” “bottom,” “upper,” “lower,” “inner,” “inwardly,” “outer” and “outwardly,” are used to assist in describing the wall mounted hitch 10 and features thereof based on the orientation of the wall mounted hitch 10 shown in the illustrations, e.g. where the wall mounted hitch 10 is mounted with its rear side abutting a wall of a building structure or other substantially vertical supporting surface. The use of directional terms should not be interpreted to limit the invention to any specific orientations, unless otherwise noted.

The terms “coupled,” “couple,” and variable thereof are used herein in their broadest sense to mean and encompass the notions of being formed or integrated with, connected, mounted, attached, or otherwise joined.

The terms “comprising” or “comprise” are used herein in their broadest sense to mean and encompass the notions of “including,” “include,” “consist(ing) essentially of,” and “consist(ing) of.” The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples.

The above description relates to general and specific embodiments of the disclosure. However, variations can be made without departing from the spirit and broader aspects of the disclosure as defined in the claims which are to be interpreted in accordance with the principles of patent law including the doctrine of equivalents. This disclosure is presented for illustrative purposes and should not be interpreted as an exhaustive description of all embodiments of the disclosure or to limit the scope of the claims to the specific elements illustrated or described in connection with these embodiments. Any reference to elements in the singular, for example, using the articles “a,” “an,” “the,” or “said,” is not to be construed as limiting the element to the singular.

What is claimed is:

1. A wall mounted hitch comprising:
a support bracket mountable to a wall of a building structure;
a hitch receiver configured to receive a shank of a hitch accessory, the hitch receiver having a proximal end and a distal end defining a receiving opening, the hitch receiver rotatable between a use position and a storage position; and
a hinge pin pivotally coupling the hitch receiver to the support bracket for rotation of the hitch receiver between the use position and the storage position, wherein the hinge pin is disposed between the proximal end and the distal end of the hitch receiver;
wherein the hitch receiver comprises an offset at the proximal end thereof such that the hitch receiver can be rotated about the hinge pin and stored within the support bracket.

2. The wall mounted hitch of claim 1 comprising a first through hole formed in the hitch receiver and a second through hole formed in the support bracket, wherein the hinge pin is received by the first and second through holes.

3. The wall mounted hitch of claim 2 comprising washers surrounding the hinge pin and disposed between the first through hole and the second through hole.

4. The wall mounted hitch of claim 1 wherein the hitch receiver comprises a hollow tubular member defining a receiving volume and having a receiving opening at the distal end thereof.

5. The wall mounted hitch of claim 4 wherein the hitch receiver comprises four side walls defining a square cross-section of the hollow tubular member.

6. The wall mounted hitch of claim 1 wherein the support bracket comprises a base plate having a rear surface and a front surface, and spaced side plates extending orthogonally relative to the front surface to define a receiving space therebetween, wherein the receiving space is sized to accommodate the hitch receiver.

7. The wall mounted hitch of claim 6 wherein the proximal end of the hitch receiver is disposed in the receiving space and the hinge pin extends between the side plates of the support bracket and through the hitch receiver.

8. The wall mounted hitch of claim 7 wherein the distal end of the hitch receiver is disposed outside the receiving space in the use position and is disposed inside the receiving space in the storage position.

9. The wall mounted hitch of claim 8 wherein the hinge pin extends orthogonally between the side plates of the support bracket, and the distal end of the hitch receiver is rotatable up and into the receiving space of the support bracket.

10. The wall mounted hitch of claim 6 wherein the base plate comprises a plurality of mounting holes that receive mounting fasteners.

11. The wall mounted hitch of claim 6 wherein the base plate comprises a top edge and a bottom edge, and a distance between the top edge and the bottom edge of the base plate is greater than a length of the hitch receiver in the storage position.

12. The wall mounted hitch of claim 6 wherein the base plate comprises a stiffening rib on the front surface of the base plate, wherein the stiffening rib is at a location coincident with the proximal end of the hitch receiver in the use position.

13. The wall mounted hitch of claim 12 wherein the stiffening rib is at a location coincident with an upper surface of a bottom wall of the hitch receiver in the use position.

14. The wall mounted hitch of claim 13 wherein the hitch receiver comprises a top wall opposing the bottom wall, and the top wall has a proximal edge disposed distally of a proximal edge of the bottom wall to form the offset.

15. The wall mounted hitch of claim 6 wherein the support bracket comprises at least one lock securing aperture in at least one of the side plates.

16. The wall mounted hitch of claim 1 wherein:
in the use position, the hitch receiver is substantially perpendicular to the support bracket; and
in the storage position, the hitch receiver is substantially parallel to the support bracket.

17. The wall mounted hitch of claim 1 wherein the hitch receiver comprises a top wall and a bottom wall, and wherein the offset comprises an offset between a proximal edge of the top wall and a proximal edge of the bottom wall.

18. The wall mounted hitch of claim 17, wherein the proximal edge of the top wall is disposed distally of the proximal edge of the bottom wall.

19. The wall mounted hitch of claim 18 wherein the hitch receiver comprises side walls joining the top wall and the bottom wall, wherein the side walls comprise angled proximal edges.

20. The wall mounted hitch of claim 1 comprising an operating load of at least 300 lbs.
